(19) United States
(12) Patent Application Publication
(10) Pub. No.: US 2002/0118762 A1
(43) Pub. Date: Aug. 29, 2002

(54) Digital audio transmission over a digital visual interface (DVI) link

(76) Inventors: Mohammad Hossein Shakiba, Toronto (CA); Sasan Nikneshan, Toronto (CA); Mehrdad Negahban, Irvine, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/852,215

(22) Filed: May 8, 2001

Related U.S. Application Data
(60) Provisional application No. 60/257,085, filed on Dec. 20, 2000.

(51) Int. Cl. H04N 7/12

(52) U.S. Cl. 375/240.28; 348/738

(57) ABSTRACT

In general, a system and method for routing audio over a Digital Visual Interface (DVI) link is described herein. In one embodiment, the system comprises a a Digital Audio Interface (DAI) transmitter and a DAI receiver. Coupled to a fourth channel of the DVI link that transmits a pixel-rate clock signal, the DAI transmitter modulates the pixel-rate clock signal by input digital audio. The DAI transmitter sends the modulated clock signal to the DAI receiver. The DAI receiver recovers the digital audio from the modulated pixel-rate clock signal.

This application claims the benefit of priority on U.S. Provisional Patent Application No. 60/257,085 filed on Dec. 20, 2000 (Attorney Docket No. 003927.P010Z).

### FIELD

The invention relates to the field of communications. In particular, one embodiment of the invention relates to a system and method for propagating audio over a Digital Visual Interface (DVI) link.

### GENERAL BACKGROUND

As electronic and computer technology continues to evolve, communication of information among different devices becomes increasingly important. It is more desirable than ever to provide efficient high-speed communication links among different devices or systems. It is particularly desirable to enable individual personal computers to have less number of wires for connection to their peripheral devices. As identified below, the Digital Visual Interface (DVI) specification defines a high-speed connection for transmitting digital video data from a computer to its display device. A large number of display devices are equipped with their own speakers and microphones. Since the handling of digital audio transmissions is not addressed by this DVI protocol, display devices featuring speakers and/or microphones require extra connections to carry audio information.

It would be beneficial and cost effective if all data transmissions, both video and audio, were possible through the DVI link.

### BRIEF DESCRIPTION OF THE DRAWINGS

The features and advantages of the invention will become apparent from the following detailed description of the invention in which:

FIG. 1 is a first exemplary embodiment of a block diagram illustrating logic that supports the transmission of a digital audio signal through a Digital Visual Interface (DVI) link without alteration of DVI connectors.

FIG. 2 is a first exemplary embodiment of a block diagram illustrating a DAI transmitter of FIG. 1.

FIG. 3 is an exemplary embodiment of a signaling diagram featuring a proposed modulation scheme.

FIG. 4 is a second exemplary embodiment of a block diagram illustrating the DAI transmitter.

FIG. 5 is a first exemplary embodiment of a block diagram illustrating the DAI receiver of FIG. 1.

FIG. 6 is an exemplary embodiment of a signaling diagram illustrating demodulation at the receiver.

FIG. 7 is a second exemplary embodiment of a block diagram illustrating the DAI receiver.

FIG. 8 is a second exemplary embodiment of a block diagram illustrating logic that supports the transmission of a digital audio signal through a DVI link without alteration of DVI connectors.

FIG. 9 is a third exemplary embodiment of a block diagram illustrating logic that supports the transmission of a digital audio signal through a DVI link without alteration of DVI connectors.

FIG. 10 is a fourth exemplary embodiment of a block diagram illustrating logic that supports the transmission of a digital audio signal through a DVI link without alteration of DVI connectors.

FIG. 11 is an exemplary embodiment of an operational flow in supporting the transmission of audio over a DVI link.

### DETAILED DESCRIPTION

Herein, the exemplary embodiments of the invention relate to a system and method for propagating a digital audio signal. In particular, the system and method utilize a mechanism to carry a digital audio signal over a Digital Visual Interface (DVI) link. Of course, the invention may be applicable to any link type that propagates data and a corresponding clocking signal such as video and a pixel clock for example. The embodiments described herein are not exclusive; rather, they merely provide a thorough understanding of the invention. Also, well-known circuits are not set forth in detail in order to avoid unnecessarily obscuring the invention.

In the following description, certain terminology is used to describe features of the invention. For example, a “video source” includes any device that can generate video such as a computer (e.g., laptop computer, network computer, personal digital assistant, etc.), a digital video disk (DVD) player, any content provider (e.g., cable company, a pay-per-view supplier, satellite television provider, etc.) and the like. “Logic” includes hardware and/or software module(s) that perform a certain function on incoming information. For example, logic may be implemented as a single electronic component (e.g., processor, controller, etc.) or multiple components (e.g. chipset).

In addition, a “link” is broadly defined as one or more physical or virtual information carrying mediums to establish a communication pathway. Examples of the medium include a physical medium (e.g., electrical wire, optical fiber, cable, bus trace, etc.) or a wireless medium (e.g., air in combination with wireless signaling technology). The term “information” is defined as voice, data, address, and/or control.

I. First Embodiment for DVI Audio Capability

A. GENERAL ARCHITECTURE

In general, one embodiment of the invention relates to the transmission of digital information, inclusive of digital audio, through a link operating in accordance with a specification by the Digital Display Working Group entitled “Digital Visual Interface DVI” (Ver. 1.0, Apr. 2, 1999). This would allow audio and video to be transmitted at the same without any additional wire, additional connectors or changes in any DVI connectors.

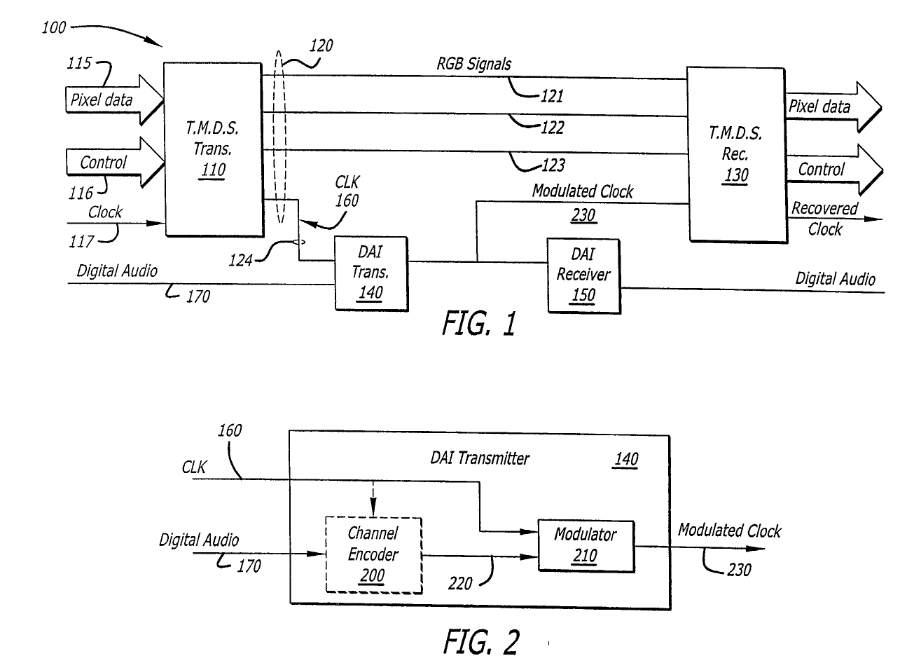

Referring to FIG. 1, a first exemplary embodiment of a block diagram illustrating logic 100 that supports audio transmissions through DVI links using both a Digital Audio Interface (DAI) transmitter and a DAI receiver is shown. This provides an ability of providing both high quality audio and video concurrently, without the need for any additional wires or changes to the DVI connectors.

As shown, the logic 100 includes a Transmission Minimized Differential Signaling (TMDS) transmitter 110 that receives video (e.g., pixel bit values) 115, control (e.g., horizontal sync “Hsync” and vertical sync “Vsync” signals) 116 and clocking signals 117 from any video source. Employed in a video source, the TMDS transmitter 110 converts the incoming video signals 115 into bit streams that are routed over DVI link 120. In particular, for this embodiment, the TMDS transmitter 110 converts a 24-bit value for each pixel into three (3) 10-bit Red Green Blue (RGB) streams. Each RGB stream includes 8-bits associated with the color signal (R, G, or B) and 2-bits for encoding overhead (if encoding utilized). Using channels 121-123 of the DVI link 120, these RGB bit streams are transmitted at a serial rate to a TMDS receiver 130. The serial rate is computed as a function of a continuous pixel-rate clock. For example, the serial rate (SR) may have a frequency multiple times higher than the pixel-rate clock (CLK) (e.g., Frequency(SR)=10×Frequency(CLK)). The RGB bit streams use almost all of the capacity associated with the channels 121-123.

A fourth channel 124 of the DVI link 120 is normally used to transmit a clock signal 160, namely the pixel-rate clock (CLK), which has a much lower pixel rate than the serial rate. Thus, there will be a large unused capacity in the fourth channel 124. This extra capacity can be used to transmit additional data such as audio data for example. However, due to limits on the maximum amount of clock jitter over the channel 124, certain constraints in data transmission capacity and signaling should be followed.

One goal for the invention is to transmit a binary sequence of audio information through the fourth channel 124 such that (i) DVI clock jitter constraints are satisfied, and (ii) the channel maintains a high quality transmission for a digital audio signal in which the bit error rate is less than a desired value. This may be accomplished by employing a Digital Audio Interface (DAI) transmitter 140 and a DAI receiver 150 as shown.

In particular, the fourth channel 124 of the DVI link 120 is used to transmit a binary sequence of audio information. The binary sequence of audio information is audio modulated along with the clock signal 160 and produced within the DAI transmitter 140. As shown, the clock signal 160 is supplied to the DAI transmitter 140 from a separate source. The DAI transmitter 140 transmits a modulated clock signal 230 (see FIG. 2) to both the TMDS receiver 130 and the DAI receiver 150. The DAI receiver 150 performs a demodulation operation on the modulated clock signal 230 and recovers a demodulated clock signal for retrieval of the audio. The TMDS receiver 130 performs the demodulation operation to obtain the clock signal 160.

B. DAI Transmitter

Referring now to FIG. 2, a first exemplary embodiment of a block diagram illustrating the DAI transmitter 140 of FIG. 1 is shown. The DAI transmitter 140 includes an optional channel encoder 200 (represented by dashed lines) and a modulator 210. When employed, the channel encoder 200 is configured to receive as input a digital audio signal 170 and converts the digital audio signal 170 into digital audio information 220 in accordance with a selected channel coding scheme such as convolutional encoding. The use of the channel encoder 200 provides a more robust output signal and mitigates any adverse effects caused by noise, which may result in a more secure transmission. Depending on the required bit rate, bit error rate and channel capacity, the channel coding scheme can be chosen.

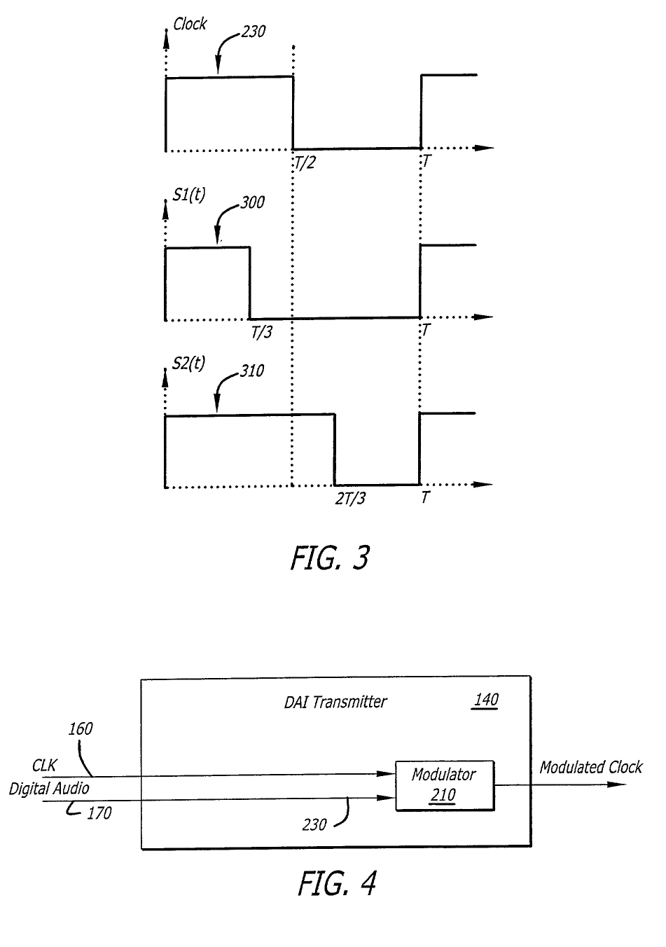

As further shown in FIGS. 2 and 3, the clock signal 160 and the digital audio information 220 are routed to the modulator 210. The digital audio information 220 may be an encoded representation of the digital audio signal 170 or equivalent to the digital audio signal 170 if no encoding is performed. The modulator 210 modulates the clock signal 160 using the digital audio information 220. With respect to the modulation scheme utilized by the modulator 210, forward compatibility to comport with revisions of the DVI specification has been considered. Since usually the TMDS receiver 130 of FIG. 1 recovers a clock signal from the transmitted clock by comparing either the rising edges or the falling edges of the received clock with a locally generated clock in a phase-locked loop (PLL) circuit, the DAI transmitter 140 may employ a pulse-width modulation (PWM) scheme. The PWM approach provides an ability to embed the modulating data (e.g., digital audio information 220) on either one of the clock edges of the modulated signal (e.g., modulated clock signal 230 as shown), while keeping the other edge unchanged. As a result, any TMDS receivers whose operation depend solely on one clock edge are not affected by the modulation. It is contemplated, however, that other modulation schemes, presently developed or developed in the future, may be utilized.

As shown in detail in FIG. 3, an exemplary embodiment of a signaling diagram featuring a modulation scheme adopted by the DAI receiver 140 and the DAI transmitter 150 is shown. The modulation scheme features binary signaling based on two non-orthogonal signals S1(t) 300 and S2(t) 310 forming the modulated (clock) signal 230. The non-orthogonal signals 300 and 310 have duty cycles with less and more than 50%, respectively. For instance, the duty cycles may be X% and (100-X)% such as duty cycles of 33% and 67% as shown.

Although the illustrated modulation scheme may not achieve the least probability of error (since the two signals do not have equal energy, e.g. in FIG. 3 E2=2E1 where “E1” and “E2” denote the energy of S1(t) 300 and S2(t) 310 respectively), it has the advantages of (i) operating on only one of the clock edges and (ii) simplicity of implementation. The aforementioned drawback could be compensated using a channel coding scheme such as convolution encoding.

It is contemplated that DVI pixel clock frequency is usually more than the required bit rate for transmission of a digital audio signal. In fact, it is appreciated that one can take advantage of the extra capacity of the channel for error correction purposes, if necessary.

Referring now to FIG. 4, a second exemplary embodiment of a block diagram illustrating the DAI transmitter 140 of FIG. 1 is shown. The DAI transmitter 140 includes the modulator 210 itself. The modulator 210 modulates the clock signal 160 by the digital audio signal 170.

C. DAI Receiver

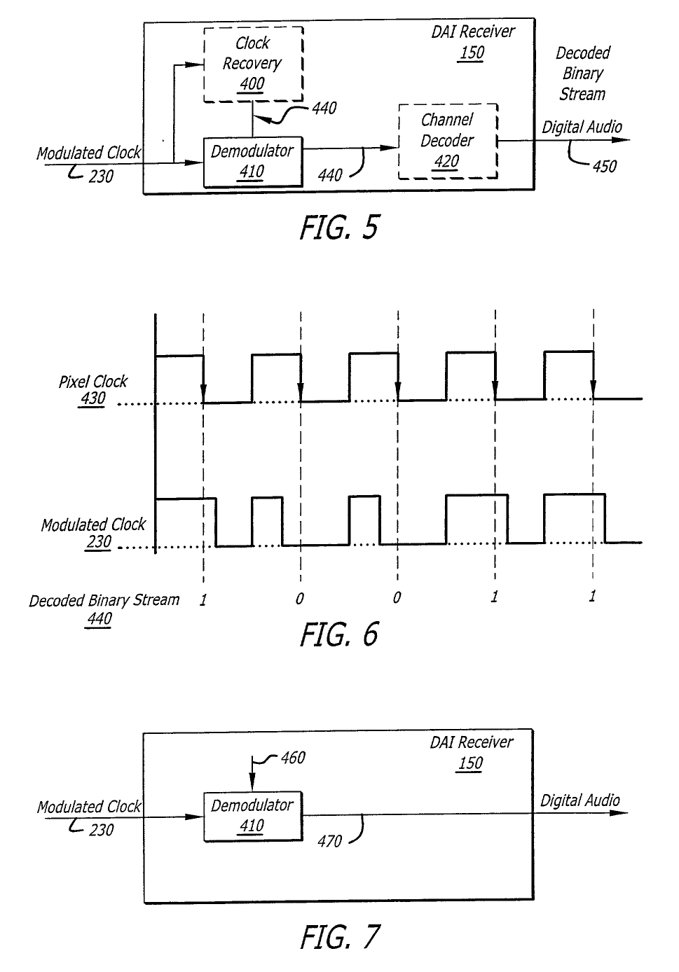

Referring now to FIG. 5, a first exemplary embodiment of a block diagram illustrating the DAI receiver 150 of FIG. 1 is shown. Herein, the DAI receiver 150 may comprise three logic units; namely, an optional clock recovery unit 400, a demodulator unit 410, and an optional channel decoder 420.

Herein, the modulated clock signal 230 passes through the clock recovery unit 400, which, in this embodiment, produces a recovered, non-modulated clock signal 430 (e.g., 50% duty cycle) from the modulated clock signal 230. The clock recovery unit 400 may include a PLL circuit as briefly described above. This recovered clock signal 430 will be used as a reference frequency by the demodulator unit 410.

In general, the demodulator unit 410 samples the modulated clock signal 230 and extracts the coded digital audio information 220 of FIG. 2. The proposed demodulation scheme makes decisions based on the samples of the modulated clock signal at “t” time instants, where

t=(2k−1)×T/2, (1)

“T” denotes the period of the original clock signal, and

“k” is a positive integer.

As shown in FIGS. 5 and 6, the modulated clock signal 230 is sampled at falling edges of the recovered clock signal 430. This produces either a logic “0” or “1”, depending upon whether S1(t) or S2(t) has been transmitted. A binary stream 440, generally equivalent to the coded digital audio information 220 of FIG. 2 if no transmission errors, passes through the channel decoder 420. The channel decoder 420 is configured to recover a decoded binary stream 450 from the binary stream 440, supposedly equivalent to the original digital audio signal(s) 170 of FIGS. 1 and 2.

Referring now to FIG. 7, a second exemplary embodiment of a block diagram illustrating the DAI receiver 150 of FIG. 1 is shown. The DAI receiver 150 comprises the demodulator unit 410. Herein, the demodulator unit 410 samples the modulated clock signal 230 and extracts the digital audio information 170 of FIG. 4. A clock signal 460, either provided from an external source or generated internally, is used as a reference frequency by the demodulator unit 410. The modulated clock signal 230 is sampled at falling edges of the clock signal 460. This produces either a logic “0” or “1”, depending upon whether S1(t) or S2(t) has been transmitted. If no transmission errors, a binary stream 470, generally equivalent to original digital audio signal 170 of FIG. 2, is output from the DAI receiver 150. Although not shown, a channel decoder may be employed within the DAI receiver 150 while a clock signal for demodulation is provided by an external source.

II. Other Embodiments for DVI Audio Capability

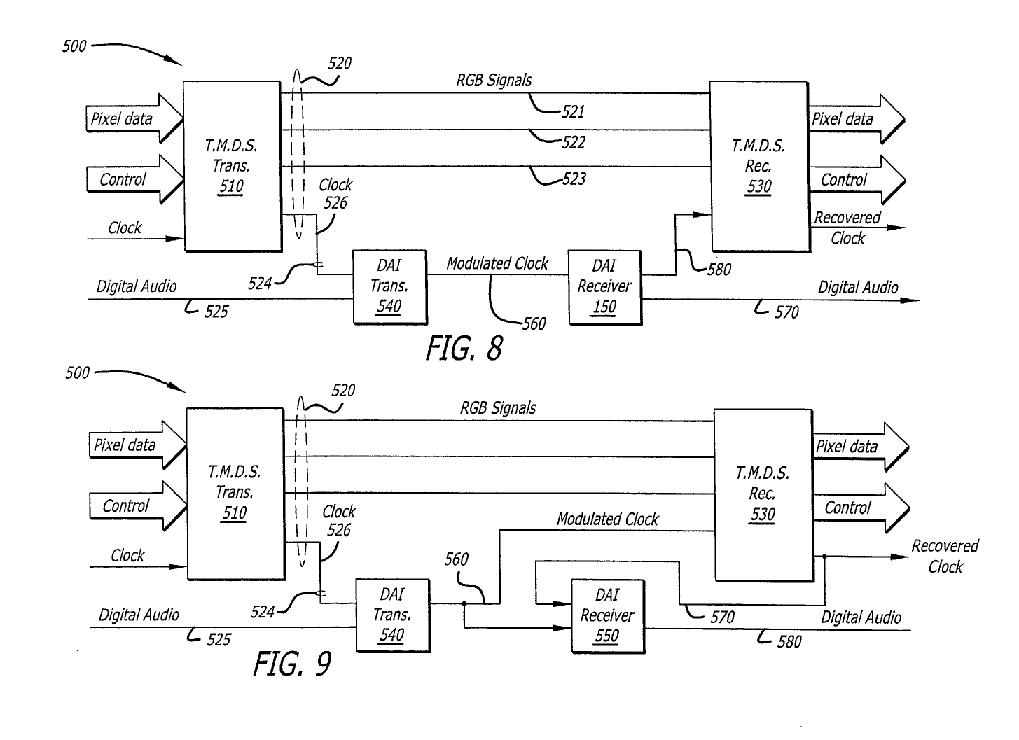

Referring to FIG. 8, a second exemplary embodiment of a block diagram illustrating logic 500 that supports the transmission of audio through the DVI link 520 using both the DAI transmitter/receiver 540 and 550 is shown. The DAI transmitter/receiver pairs that may be employed are illustrated in FIGS. 2 and 5 and FIGS. 4 and 7, respectively. The DAI transmitter/receiver pair of FIGS. 2 and 5 can be employed when channel encoding is desired.

Similar to FIG. 1, the fourth channel 524 is used to transmit the clock signal 526 modulated by digital audio 525. However, the DAI transmitter 540 transmits a modulated clock signal 560 to only a DAI receiver 550. The DAI receiver 550 performs a demodulation operation on the modulated clock signal 560 and recovers both the audio 570 and a demodulated clock signal 580. The digital audio 570 is output, but the demodulated clock signal 580 is supplied to the TMDS receiver 530 as shown. To support backward comparability, it is contemplated that the demodulated clock signal 580 may be generally equivalent to the clock signal 526 supplied to the DAI transmitter 540. The audio 570 is substantially equivalent to digital audio 525.

Referring to FIG. 9, a third exemplary embodiment of a block diagram illustrating logic 500 that supports the transmission of a digital audio signal through the DVI link 520 using both the DAI transmitter/receiver 540 and 550 is shown. Similar to FIGS. 1 and 8, the fourth channel 524 is used to transmit clock signal 526 modulated by the digital audio 525. The modulated clock signal 560 is provided to both the TMDS receiver 530 and the DAI receiver 550. The TMDS receiver 530 performs a demodulation operation on the modulated clock signal 560 to recover a demodulated clock signal 570. The recovered (demodulated) clock signal 570 is supplied from the TMDS receiver 530 to the DAI receiver 550 as shown. The DAI receiver 550 uses the recovered (demodulated) clock signal 570 to extract the digital audio 580 from the modulated clock signal 560. If no transmission errors, the audio 580 is equivalent to the digital audio 525.

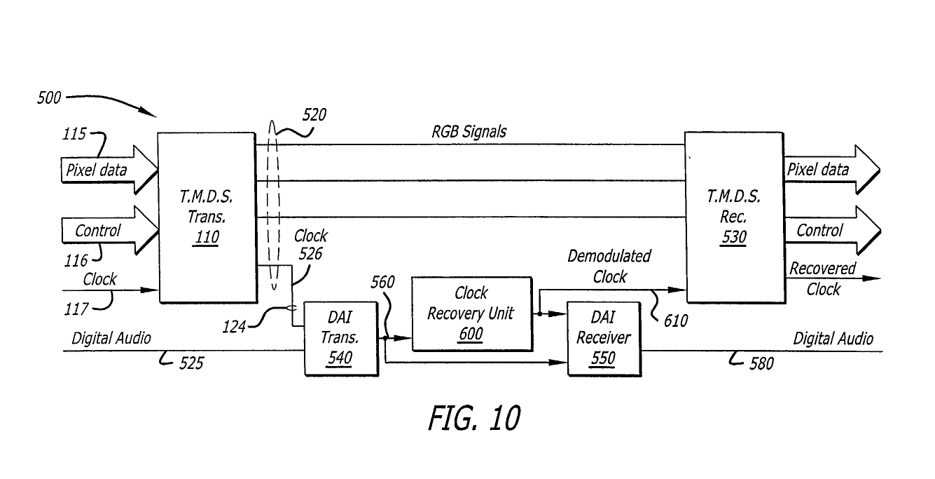

Referring to FIG. 10, a fourth exemplary embodiment of a block diagram illustrating logic 500 that supports the transmission of a digital audio signal through the DVI link 520 using both the DAI transmitter/receiver 540 and 550 is shown. Similar to FIGS. 1, 8 and 9, the fourth channel 524 is used by the DAI transmitter 540 to produce a modulated clock signal 560 by modulating the clock signal 526 with the digital audio 525. However, the DAI transmitter 540 transmits the modulated clock signal 560 to a separate clock recovery unit 600 and the DAI receiver 550. The clock recovery unit 600 performs a demodulation operation on the modulated clock signal 560 and recovers, if no transmission errors, a demodulated clock signal 610. The recovered (demodulated) clock signal 610 is supplied to both the TMDS receiver 530 and the DAI receiver 550 as shown. The demodulated clock signal 610 may be equivalent to the clock signal 526. The DAI receiver 550 uses the recovered clock signal 610 to extract the digital audio 580 from the modulated clock signal 560. The digital audio 580 is output from the DAI receiver 550.

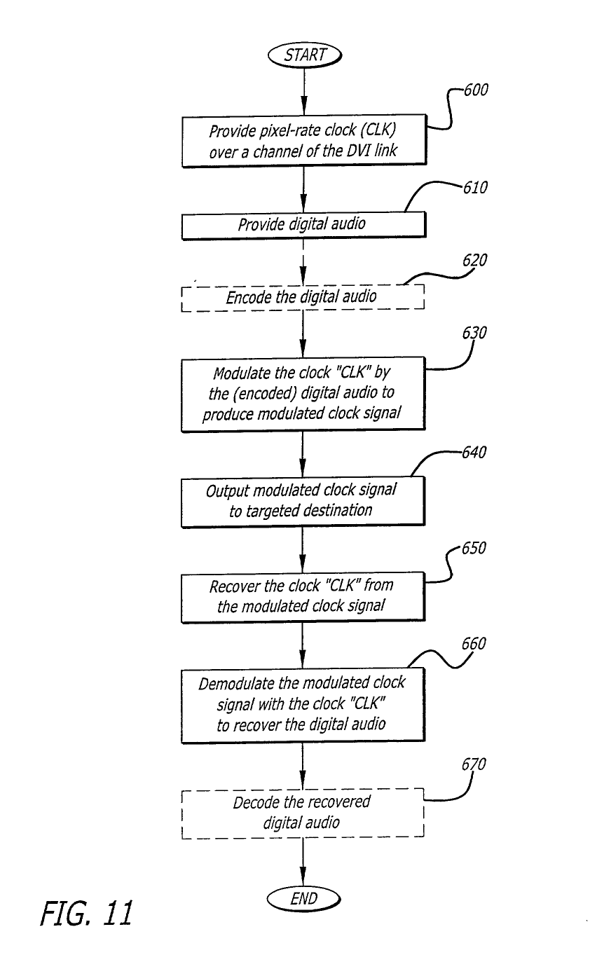

Referring now to FIG. 11, an exemplary embodiment of an operational flow in supporting the transmission of audio over a DVI link is shown. The pixel-rate clock (CLK) is provided over a channel of the DVI link (block 600). In addition, audio is supplied at a source in a digital format or an analog format that is later digitalized (block 610). Thereafter, as an optional operation represented by dashed lines, the digital audio may be encoded (block 620). The clock supplied by the DVI link channel (e.g., fourth channel) is modulated by the (encoded) digital audio as shown in block 630. This produces a modulated clock signal, which is output to a targeted destination as shown in block 640.

Upon receipt of the modulated clock signal, it is demodulated to recover the pixel-rate clock (CLK) in accordance with block 650. Using the recovered pixel-rate clock, the digital audio may be recovered (block 660). If necessary, the recovered digital audio is decoded to obtain the original audio supplied at the source (block 670).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. For example, it may be possible to implement the invention or some of its features in hardware, firmware, software or a combination thereof where the software is provided in a processor readable storage medium such as a magnetic, optical, or semiconductor storage medium. This software may be configured as one or more routines each performing one or more operations described in FIG. 1 through FIG. 11, respectively.

What is claimed is:

1. A Digital Audio Interface (DAI) transmitter, comprising:
a first input to receive a clock signal over a selected channel of a Digital Visual Interface (DVI) link;
a second input to receive digital audio; and
a modulator coupled to the first input and the second input, the modulator to modulate the clock signal by the digital audio.

2. The DAI transmitter of claim 1, wherein the DVI link includes a plurality of channels of which the selected channel provides the clock signal at a pixel-rate less than a serial rate for transmission of data streamed over other channels of the plurality of channels.

3. The DAI transmitter further comprising:
an encoder coupled to the second input, the encoder to encode the digital audio before receipt by the modulator.

4. The DAI transmitter of claim 3, wherein the digital audio used for modulation of the clock signal is encoded.

5. The DAI transmitter of claim 1 being coupled to a DAI receiver for recovery of the digital audio from the modulated clock signal.

6. The DAI transmitter of claim 5 being further coupled to a Transmission Minimized Differential Signaling (TMDS) receiver over the DVI link, the TMDS receiver to receive the modulated clock signal.

7. A Digital Audio Interface (DAI) receiver, comprising:
an input to receive a modulated clock signal being formed by a clock signal over a Digital Visual Interface (DVI) link modulated by digital audio; and
a demodulator coupled to the input, the demodulator to recover the digital audio from the modulated clock signal.

8. The DAI receiver of claim 7, further comprising:
a clock recovery unit coupled to the input, the clock recovery unit to recover the clock signal from the modulated clock signal and to provide the recovered clock signal to the demodulator.

9. The DAI receiver of claim 7 being coupled to a Transmission Minimized Differential Signaling (TMDS) receiver to receive a clock signal recovered from the modulated clock signal.

10. The DAI receiver of claim 8 further comprising:
a decoder coupled to the demodulator to decode the recovered digital audio.

11. The DAI receiver of claim 7 being coupled to a clock recovery unit, receiving a recovered clock signal from the clock recovery unit, and using the recovered clock signal to recover the digital audio from the modulated clock signal.

12. A system comprising:
a Digital Visual Interface (DVI) link including a plurality of channels, one of the plurality of channels to transmit a pixel-rate clock signal;
a Digital Audio Interface (DAI) transmitter coupled to the one of the plurality of channels, the DAI transmitter to modulate the pixel-rate clock signal by digital audio; and
a DAI receiver coupled to the DAI transmitter, the DAI receiver to recover the digital audio from the modulated pixel-rate clock signal.

13. The system of claim 12, wherein at least three of the plurality of channels to transmit data streams at a serial rate having a frequency substantially greater than a frequency of the pixel-rate clock signal.

14. The system of claim 13, wherein the serial rate is ten times greater than the frequency of the pixel-rate clock signal.

15. The system of claim 12, wherein the DAI transmitter to encode the digital audio and to modulate the pixel-rate clock signal with the encoded digital audio.

16. The system of claim 15, wherein the DAI receiver to demodulate the modulated pixel-rate clock signal to recover the encoded digital audio and then decode the encoded digital audio.

17. The system of claim 12, wherein the DAI receiver to receive a clock signal from a source and use the clock signal to recover the digital audio from the modulated pixel-rate clock signal.

18. The system of claim 17, wherein the clock signal is a recovered clock signal from the modulated pixel-rate clock signal.

19. The system of claim 18, wherein the source is a Transmission Minimized Differential Signaling (TMDS) receiver.

20. A method comprising:
receiving a clock signal over a channel of a Digital Visual Interface (DVI) link;
receiving digital audio;
modulating the clock signal by the digital audio to produce a modulated clock signal; and
outputting the modulated clock signal for subsequent recovery of the digital audio.

21. The method of claim 20, wherein the outputting of the modulated clock signal further comprises:
transmitting the modulated clock signal over a dedicated link;
recovering the clock signal from the modulated clock signal; and
recovering the digital audio by demodulating the modulated clock signal using the recovered clock signal.

22. A method for transmission of digital audio over a Digital Visual Interface (DVI) link, the method comprising:
receiving a clock signal over a channel of the DVI link;
receiving digital audio;
encoding the digital audio;
modulating the clock signal by the encoded digital audio to produce a modulated clock signal; and
outputting the modulated clock signal for subsequent recovery of the digital audio.

23. The method of claim 22, wherein the outputting of the modulated clock signal further comprises:
transmitting the modulated clock signal over a dedicated link;
recovering the clock signal from the modulated clock signal;
recovering the encoded digital audio by demodulating the modulated clock signal using the recovered clock signal; and
decoding the encoded digital audio to recover the digital audio.
